(19) United States
(12) Patent Application Publication
(10) Pub. No.: US 2008/0169308 A1
(43) Pub. Date: Jul. 17, 2008

(54) Circulation system for delivering and dispensing bottled fluid

(76) Inventor: Eugene M. Martin, Marion, SC (US)

Correspondence Address: P. JEFF MARTIN OF THE McGOUGAN LAW FIRM, LLC;P.O. BOX 4369, 2120 SEA MOUNTAIN HWY., N. MYRTLE BEACH, SC, 29597, US

(21) Appl. No.: 11/654,458

(22) Filed: Jan. 17, 2007

(51) Int. Cl. B67D 5/62; B67D 5/08

(52) U.S. Cl. 222/64; 62/389; 62/397; 222/146.1; 222/146.6

(57) ABSTRACT

A water circulation system for distributing bottled fluid to a remote location.

### RELATED APPLICATIONS

There are no previously filed, nor currently any co-pending applications, anywhere in the world.

### BACKGROUND OF THE INVENTION

1. Field of the Invention

The present invention relates generally to installations for circulating water in potable water piping systems, and more particularly, to a circulation system for delivering and dispensing bottled fluid.

2. Description of the Related Art

Until recently, bottled water dispensers underwent relatively few major innovations over the years. Machines capable of dispensing chilled water were the norm. Units capable of dispensing heated water were available, but were not common. Today, units with this feature are far more popular. In addition, modern units now feature special receptacles in the upper portions of their reservoirs. When loaded with special valve-equipped bottles, they largely eliminate the spillage associated with older water coolers. Many water coolers are now also augmented with a small refrigerator compartment on their lower ends. Large enough to hold a few cans of soda pop and a bag lunch, they are well suited for small offices and related locations.

However these traditional water dispensers fail to teach or provide a countertop or wall-mounted tap being remotely linked to a main storage unit by means of a circulation loop. The storage unit is installed in a utility room, basement, or related location, and would incorporate a pump adapted to continuously circulate chilled or heated fluid or water through the loop and supply the fluid under pressure upon opening of the tap. It is envisioned that storage unit may also incorporate a pump adapted to circulate chilled or heated fluid or water through the loop and supply the fluid under pressure upon opening of the tap in accordance to a preset circulation period, wherein fluid circulation period being controlled by a circulation control timer.

Accordingly, a need has arisen for a water circulation system for distributing bottled fluid to a remote location in a manner which is quick, easy, and efficient. The development of the circulation system for delivering and dispensing bottled fluid fulfills this need.

A search of the prior art did not disclose any patents that read directly on the claims of the instant invention; however, the following references were considered related.

U.S. Pat. No. 6,920,897, issued in the name of Poirier discloses a system for circulating potable water in a closed loop system for prevention stagnation.

U.S. Pat. No. 4,457,326, issued in the name of Donnelly discloses a system for providing temporary water service between a water main and one or more locations normally connected to the main in which a pipeline is provided above ground, and has a supply section and a return section which are connected to the main.

U.S. Pat. No. 6,705,344, issued in the name of Poirier discloses a water circulating system which circulates potable water.

U.S. Pat. No. 6,895,985 B2, issued in the name of Popper et al. discloses a closed loop system for providing water at different temperatures.

U.S. Pat. No. 4,232,657, issued in the name of Killorin discloses a water storage tank which has a heat exchange element mounted therein and a tank connected to one or more solar collectors adapted to heat water circulated through a primary loop by associated pumps.

U.S. Pat. No. Des. 289,724, issued in the name of Runyon discloses the ornamental design for a bottled water dispenser.

U.S. Pat. No. Des. 313,330, issued in the name of Brusa discloses the ornamental design for a bottled water dispenser.

Consequently, a need has been felt for a water circulation system for distributing bottled fluid to a remote location in a manner which is quick, easy, and efficient.

### SUMMARY OF THE INVENTION

Therefore, it is an object of the present invention to provide a water circulation system having a storage unit and a dispensing unit.

It is another object of the present invention to provide a dispensing unit coupled to circulation system via closed loop plumbing.

It is another object of the present invention to provide a dispensing unit placed remotely to the storage unit.

It is another object of the present invention to provide a pump coupled to closed loop plumbing, wherein pump urges bottled water from the storage unit to the dispensing unit through the closed loop plumbing.

It is another object of the present invention to provide a dispensing unit which includes at least one control or a plurality of controls, a rotatable faucet control, or at least one movable faucet arm, or a depressable valve, a motion sensitive eye for opening and closing the outlet line, or other similar means for opening and closing the outlet line through which the quantity of fluid will be delivered to the user.

It is still another object of the present invention to provide a remote indicator light/system to indicate that fluid in storage tank needs to be replenished.

Briefly described according to one embodiment of the present invention, a circulation system for distributing bottled fluid is described, the system comprising a storage unit and a dispensing unit, the storage unit and dispensing unit coupled via closed loop plumbing; the dispensing unit placed remotely to the storage unit; a pump coupled to the closed loop plumbing, the pump urging the bottled fluid from the storage unit to the dispensing unit through the closed loop plumbing. The housing may comprise one, several or all of the following elements, including a storage tank for storing fluid; a pressure tank coupled to the storage tank; a sealed refrigeration system for cooling the stored fluid; a pressure pump coupled to the circulation loop, the pump urging the fluid through the circulation loop for dispensing the fluid; a circulation pump coupled to the pressure tank, the circulation pump receiving a return tube of the circulation loop; a cooling system coupled to the housing for cooling the unit during operation; a receiver for a bottle of fluid, the receiver in fluid communication with the storage tank; a control panel, the control panel including means to control the fluid temperature, the pressure and the circulation time; an emergency check valve and pressure release valve; a door having a handle; a plurality of knockout holes for arranging plumbing lines therethrough; and means for determining the fluid level within the storage tank.

The dispensing unit comprises at least one outlet for dispensing a quantity of fluid.

In accordance with another embodiment, a fluid circulation device for delivering bottled fluid to a user is described, the device comprising a storage unit and a dispensing unit, the storage unit and dispensing unit coupled via a circulation loop; the storage unit comprising a housing. The housing comprises a storage tank for storing fluid; a pressure tank coupled to the storage tank; a sealed refrigeration system for cooling the stored fluid; a pressure pump coupled to the circulation loop, the pump urging the fluid through the circulation loop for dispensing the fluid; a circulation pump coupled to the pressure tank, the circulation pump receiving a return tube of the circulation loop; a cooling system coupled to the housing for cooling the unit during operation; a receiver for a bottle of fluid, the receiver in fluid communication with the storage tank; the dispensing unit comprising at least one outlet for dispensing a quantity of fluid; an emergency check valve and pressure release valve; at least one drain line extending from the storage tank; at least one drain line extending from the pressure tank; a door having a handle; a plurality of knockout holes for arranging plumbing lines therethrough; means for determining the fluid level within the storage tank; a control panel, the control panel including means to control the fluid temperature; a control panel, the control panel including means to control the pressure; a control panel, the control panel including means to control the circulation time.

In accordance with another embodiment, a method for delivering consumable fluid to a user at a remote location comprising the steps of: providing a storage unit receiving a quantity of bottled fluid, the fluid stored in the storage unit; providing a dispensing unit coupled to the storage unit, the dispensing unit remotely located relative to the storage unit; and dispensing a quantity of the stored fluid through an outlet in the dispensing unit. The method may further include the step of providing a closed loop plumbing for coupling the storage unit and the dispensing unit. The method may further include the step of providing a pump coupled to the plumbing, wherein dispensing a quantity of the stored fluid includes actuating a pump for urging the fluid through the plumbing. The method may further include the step of dispensing the fluid at a specified temperature to the user through the outlet. The method may further include the step of moving the dispensing unit into a position for use at the remote location.

The use of the present invention provides user with a water circulation system which distributes bottled fluid to a remote location in a manner which is quick, easy, and efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front view of a fluid dispensing system comprising a storage unit and a dispensing unit coupled via plumbing;

FIG. 2 is a front or rear view of the housing of the storage unit, including the components of the housing and storage unit;

FIG. 3 is a front or rear view of the housing of the storage unit with the exterior intact;

FIG. 4 is a front view of the dispensing unit; and

FIG. 5 is a block diagram of a method for dispensing fluid.

### DESCRIPTION OF THE PREFERRED EMBODIMENT

### 1. Detailed Description of the Figures

In contrast to existing bottled water dispensing systems, wherein a five (5) gallon bottle is placed upon a dispensing pedestal for local distribution of bottled water, the device, system and method disclosed herein describes the circulation of bottled fluid, typically water but envisioned to include other consumable fluids, including power (electrolyte replenishment) drinks or other such fluids, from a source to an outlet, wherein the source and the outlet are coupled to one another via closed loop plumbing, and wherein the source and the outlet are remotely separated from one another. In this manner, office or home space utilization is optimized.

For purposes of explanation of the invention, the fluid discussed herein is usually bottled spring water or drinking water. However, the invention is not limited to water as the fluid, and as such, all consumable fluid beverages are considered to be within the scope of the invention discussed herein. It should also be noted that while discussion of the invention will include the cooling or chilling of fluid, it is equally envisioned that the fluid may be warmed or heated for particular purposes, as well.

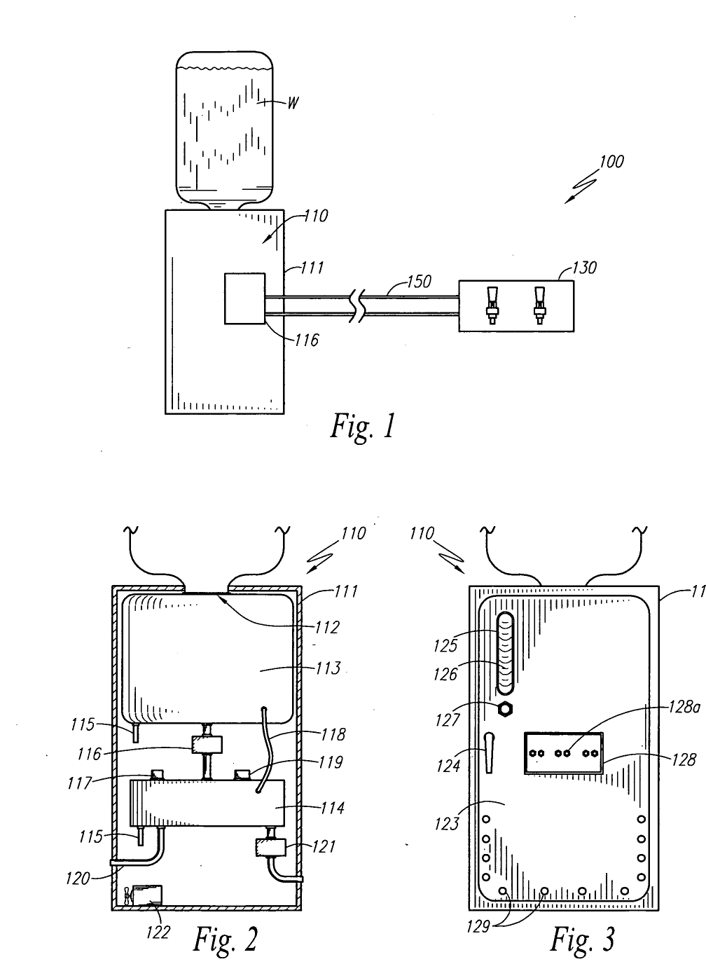

Referring now to FIG. 1 through FIG. 4, a system 100 for delivering and dispensing fluid to a user is depicted in accordance with at least one embodiment of the invention. The system 100 comprises a storage unit 110 and a dispensing unit 130, the storage unit 110 and dispensing unit 130 coupled to one another via closed loop plumbing 150. The storage unit 110 and the dispensing unit 130 are remotely separated from one another, rather than comprising a single unit in the same location. The system 100 also includes a pump 116 coupled to the closed loop plumbing 150, the pump 116 urging the bottled water “w” from the storage unit 1 10 to the dispensing unit 130 through the closed loop plumbing 150. The plumbing 150 may be achieved by utilizing flexible plastic tubing with secured couplings at the ends and at junctions (if necessary).

Referring now to FIG. 2 and FIG. 3, the storage unit 110 comprises a housing 111 and a dispensing unit 130, the storage unit 110 and the dispensing unit 130 coupled via a circulation loop, such as the closed loop plumbing 150 noted above, or other equivalent means. Internally, the housing 111 includes a receiver 112 for receiving and seating the neck of the five (5) gallon bottle of fluid. The receiver 112 is in fluid communication with a storage tank 113 for storing the fluid temporarily. The storage tank 113 may have a variety of capacities, depending upon the size of the unit. For instance, in one envisioned embodiment, and as but one example, the tank 113 may have the capacity to store five (5) gallons of water or fluid. In another envisioned embodiment, the capacity of the tank 113 may comprise a volume of approximately ten (10) gallons, allowing for the storage of five (5) gallons of water within the tank 113 and allowing an addition five (5) gallon unit to be poised for entry as the tank 113 is depleted. Other capacities, including smaller and larger capacities, are envisioned so as to accommodate variously sized water dispensing needs.

The housing 111 may also include a pressure tank 114. The storage tank 113 and/or the pressure tank 114 may include at least one drain 115 for any overflow. A pressure pump 116 is coupled between the storage tank 113 and the pressure tank 114. The pressure tank 114 may have a variety of capacities. In one embodiment, and but as one example, the pressure tank 114 may have a capacity of approximately two (2) gallons. The pressure tank 114 may include at least one pressure sensor 117 for actuating the pressure pump 116 to release a quantity of the stored fluid from within the storage tank 113 into the pressure tank 114. The pressure tank 114 may also include at least one emergency check value/pressure release valve 118 for controlling the pressure within the tank 114. The housing 111 may also include a sealed refrigeration system 119 for cooling or chilling the fluid as desired.

The pressure tank 114 may also include at least one outlet tube 120 that may be oriented to run or communicate with a variety of locations. The pressure tank 114 is coupled to a circulation pump 121. The circulation pump 121 is coupled to and is in fluid communication with one portion of the loop 150, envisioned as the return loop of the circulation lines or plumbing. It is also envisioned that the housing 111 may include a cooling system 122 for the unit to control the internal temperature during operation and prevent malfunctioning or destruction of the device.

Externally, it is envisioned that the housing 111 may comprise a durable and insulated material, such as a variety of plastics or other suitable materials. The materials will extend the useful life of the housing 111 (and storage unit 110) and provide the appropriate and sufficient level of insulation required for cooling units of this variety. The housing 111 may include a door 123 and a door handle 124 for providing entry into the internal area of the housing 111. The housing 111 may also include knockout holes 129 within the door 123 or along another panel or panels of the housing 111 so that suitable access for tubes, lines and/or plumbing may be achieved. The housing 111 may also include visual means 125, such as a clear pane of glass or plastic corresponding to the storage tank 113, thereby allowing a user to visually inspect the fluid level within the storage tank 113. Visual means 125 may also include indicia 126 to provide reference to previous levels, or to provide accurate measurement of the volume remaining in the tank 113. Furthermore, an indicator light/system 127 provided on the door 123 of housing 111 to indicate that fluid needs to be replenished may be included as a substitute or in combination and communication with the storage tank 113. Thus, if the fluid level within the tank 113 falls below a predetermined threshold, then the indicator light or system 127 will be actuated to indicate that the fluid levels need to be replenished. A wireless, remote indicator light/system 127a is provided on the dispensing unit 130 to alert user that fluid within storage tank 113 needs to be replenished. The wireless, remote indicator light/system 127a is in wireless communication with the storage tank 113. Thus, in the event the fluid level within the tank 113 falls below a predetermined threshold, the remote indicator light/system 127a is adapted to be actuated to indicate that the fluid levels need to be replenished. The housing 111 may also include a control panel 128 operatively coupled with the pumps 116, 121 and pressure tank 114, thereby allowing the user(s) to control elements such as fluid temperature settings, pressure settings, fluid circulation time and other similar settings.

The pump 116 is adapted to supply the chilled or cooled fluid to a remotely positioned dispenser, faucet, tap, or control 131, generally envisioned as provided on the dispensing unit 130 (and described in further detail below). The pump 116 continuously circulates chilled fluid through the loop 150 and supplies the fluid under pressure when the dispenser, faucet or tap is opened by a user. The pump 116 may operate in conjunction with the circulation pump 121 for providing a continuous or regular circulation loop of the fluid through the device or system. The pump 116 is further adapted to circulate chilled fluid through the loop and supply the fluid under pressure upon opening of the tap or control 131 in accordance to a preset circulation period, wherein fluid circulation period is controlled by a circulation control timer 128a provided on control panel 128.

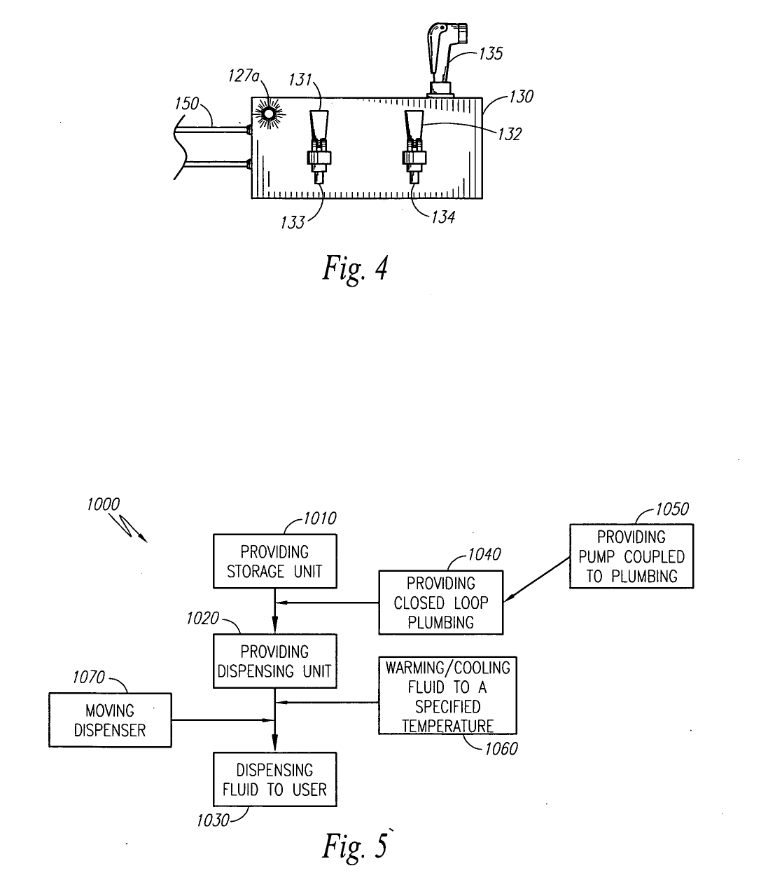

Referring now to FIG. 4, the dispensing unit 130 may include a variety of devices or apparatuses that are capable of delivering a controlled quantity of fluid from the storage unit 110 to the beverage holder or cooking pot of the user. The dispensing unit 130 may include at least one control 131 (or a plurality of controls 131 and 132), rotatable faucet control, or at least one movable faucet arm, or a depressable valve, a motion sensitive eye for opening and closing the outlet line, or other similar means for opening and closing the outlet line through which the quantity of fluid will be delivered to the user. It is also envisioned that a separate hose 135 may be used as a substitute to the control(s) 131 or 132, or in combination with the controls 131 or 132. The dispensing unit 130 is envisioned to include a number of variations adaptable for a variety of home or office environments, including countertop models, table top models, floor models, hidden models, and other similar variations. For instance, one variation may include a countertop model with at least one outlet 133 (or a plurality of outlets 133 and 134) corresponding with at least one control 131 (or 131 and 132, if applicable). It is further envisioned that the dispensing unit 130 is portable within a general vicinity of the room that the unit 130 is placed, so that the unit 130 may be neatly stored in a corner of the countertop space when not used, and then easily moved into position (such as near or adjacent a sink or disposal) for use.

Referring now to FIG. 5, a method 1000 for delivering consumable fluid to a user at a remote location is described, the method comprising the steps of: providing a storage unit receiving a quantity of bottled fluid 1010, the fluid stored in the storage unit; providing a dispensing unit coupled to the storage unit 1020, the dispensing unit remotely located relative to the storage unit; and dispensing a quantity of the stored fluid through an outlet in the dispensing unit 1030. The method may further include the step of providing a closed loop plumbing for coupling the storage unit and the dispensing unit 1040. The method may further include the step of providing a pump coupled to the plumbing, wherein dispensing a quantity of the stored fluid includes actuating a pump for urging the fluid through the plumbing 1050. The method may further include the step of dispensing the fluid at a specified temperature to the user through the outlet 1060. The method may further include the step of moving the dispensing unit into a position for use at the remote location 1070.

### 2. Operation of the Preferred Embodiment

To use the present invention, user simply manipulates the remotely placed dispenser control 131 so as to deliver a controlled quantity of water or fluid from the storage unit 110 to a beverage holder or other suitable container.

The use of the present invention provides user with a water circulation system which distributes bottled fluid to a remote location in a manner which is quick, easy, and efficient.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. A circulation system for distributing bottled fluid comprising:
a storage unit and a dispensing unit, the storage unit and the dispensing unit coupled via closed loop plumbing;
the dispensing unit placed remotely to the storage unit; and
a pump coupled to the closed loop plumbing, the pump urging the bottled fluid from the storage unit to the dispensing unit through the closed loop plumbing.

2. The system of claim 1, wherein the storage unit comprises a housing, the housing comprising:
a storage tank for storing fluid;
a pressure tank coupled to the storage tank;
a sealed refrigeration system for cooling the stored fluid;
a pressure pump coupled to the circulation loop, the pump urging the fluid through the circulation loop for dispensing the fluid;
a circulation pump coupled to the pressure tank, the circulation pump receiving a return tube of the circulation loop;
a cooling system coupled to the housing for cooling the unit during operation; a receiver for a bottle of fluid, the receiver in fluid communication with the storage tank;
a control panel, the control panel including means to control the fluid temperature, the pressure and the circulation time; and
an emergency check valve and pressure release valve.

3. The system of claim 2, the housing further comprising a door having a handle.

4. The system of claim 2, the housing further comprising a plurality of knockout holes for arranging plumbing lines therethrough.

5. The system of claim 2, the housing further comprising means for determining the fluid level within the storage tank.

6. The system of claim 1, wherein the dispensing unit comprises at least one outlet for dispensing a quantity of fluid.

7. A fluid circulation device for delivering bottled fluid to a user, the device comprising:
a storage unit and a dispensing unit, the storage unit and the dispensing unit coupled via a circulation loop;
the storage unit comprising a housing, the housing comprising:
a storage tank for storing fluid;
a pressure tank coupled to the storage tank;
a sealed refrigeration system for cooling the stored fluid;
a pressure pump coupled to the circulation loop, the pump urging the fluid through the circulation loop for dispensing the fluid;
a circulation pump coupled to the pressure tank, the circulation pump receiving a return tube of the circulation loop;
a cooling system coupled to the housing for cooling the unit during operation; and
a receiver for a bottle of fluid, the receiver in fluid communication with the storage tank, the dispensing unit comprising at least one outlet for dispensing a quantity of fluid.

8. The device of claim 7, the housing further comprising an emergency check valve and pressure release valve.

9. The device of claim 7, the housing further comprising at least one drain line extending from the storage tank.

10. The device of claim 7, the housing further comprising at least one drain line extending from the pressure tank.

11. The device of claim 7, the housing further comprising a door having a handle.

12. The device of claim 7, the housing further comprising a plurality of knockout holes for arranging plumbing lines therethrough.

13. The device of claim 7, the housing further comprising means for determining the fluid level within the storage tank.

14. The device of claim 7, the housing further comprising a control panel, the control panel including means to control the fluid temperature.

15. The device of claim 7, the housing further comprising a control panel, the control panel including means to control the pressure.

16. The device of claim 7, the housing further comprising a control panel, the control panel including means to control the circulation time.

17. A method for delivering consumable fluid to a user at a remote location comprising the steps of:
providing a storage unit receiving a quantity of bottled fluid, the fluid stored in the storage unit;
providing a dispensing unit coupled to the storage unit, the dispensing unit remotely located relative to the storage unit; and
dispensing a quantity of the stored fluid through an outlet in the dispensing unit.

18. The method of claim 17, further comprising the step of providing a closed loop plumbing for coupling the storage unit and the dispensing unit.

19. The method of claim 18, further comprising the step of providing a pump coupled to the plumbing.

20. The method of claim 19, wherein dispensing a quantity of the stored fluid includes actuating a pump for urging the fluid through the plumbing.

21. The method of claim 17, further comprising the step of dispensing the fluid at a specified temperature to the user through the outlet.

22. The method of claim 17, further comprising the step of moving the dispensing unit into a position for use at the remote location.
